(19) United States
(12) Patent Application Publication
(10) Pub. No.: US 2012/0061003 A1
(43) Pub. Date: Mar. 15, 2012

(54) METHOD OF JOINING AT LEAST TWO COMPONENTS

(75) Inventors: Willi Bartholomeyzik, Hassloch (DE); Martin Völker, Bechtheim (DE)

(73) Assignee: BASF SE, Ludwigshafen (DE)

(21) Appl. No.: 13/228,055

(22) Filed: Sep. 8, 2011

Related U.S. Application Data
(60) Provisional application No. 61/381,094, filed on Sep. 9, 2010.

(51) Int. Cl. B32B 7/08

(52) U.S. Cl. 156/92

(57) ABSTRACT

The invention relates to a method of joining at least two components, in which a pin (3, 25) of a thermoplastic plastics material is heated, such that it becomes at least partially deformable, the pin (3, 25) of thermoplastic plastics material is guided through an opening (21) in the second component (5), the pin (3, 25) being joined to the first component (1) or guided beforehand as a separate component through a first opening (27) in the first component (1), and the heated pin (3, 25) of thermoplastic plastics material is pressed, such that the pin (3, 25) is applied against the wall of the opening (21) in the second component (5), the wall taking the form of an internal thread (19), or the pin (3, 25) is inserted into a sleeve (9) provided with an internal thread (13) and pressed, such that it is applied against the internal thread (13) of the sleeve (9), the pin (3, 25) being heated prior to being passed through the opening (21) in the second component (5) or after insertion into the opening (21) in the second component (5) or into the sleeve (9).

The invention relates to a method of joining at least two components, in which the components are provided with openings through which a plastics pin is passed and then pressed.

The method according to the invention may in particular be used to achieve initial fixing for bonding, for example to obtain a media-tight joint between the components. In known methods, with which a plastics part is for example adhesively bonded to a metal part, it is necessary during the adhesive hardening period to use clips or clamps to fix the components in place. When using silicone adhesives in particular, which sometimes take several days to harden, this means that the components have initially to be left after bonding until the adhesive has achieved a minimum strength. During this period the components must not be subjected to loads.

As well as securing with clamps or clips, it is alternatively also known to screw the components to one another prior to bonding. It is additionally also known to use rivets to join plastics parts to metal parts. Riveting of plastics parts to metal parts is described in DE-A 1 778 433 for example. For riveting, projections are formed on plastics components which are introduced into corresponding openings in the metal component and heated by vibration. However, a disadvantage of this is that the joint is permanent and the plastics component may be damaged if the joint is undone, the rivets at least being broken off, so making it impossible to join the plastics component back to the metallic component.

Insertion of a seal leads in general to forces being exerted on the plastics part, which may lead to deformation of the plastics part. For this reason, adhesive bonds are used to achieve media-tight joining of a metal component to a plastics component, for example when using plastics engine components.

It is an object of the invention to provide a method of joining at least two components which allows a media-tight joint even in the case of surfaces which are not wholly plane-parallel and in which the components are exposed to only slight reaction forces.

The object is achieved by a method of joining at least two components which comprises the following steps:
(a) heating a pin of a thermoplastic plastics material, such that it is at least partially deformable,
(b) guiding the pin of thermoplastic plastics material through an opening in the second component, the pin being joined to the first component or passed beforehand as a separate component through a first opening in the first component,
(c) pressing the heated pin of thermoplastic plastics material, such that the pin is applied against the wall of the opening in the second component, the wall taking the form of an internal thread, or inserting the pin into a sleeve provided with an internal thread and pressing the pin, such that the latter is applied against the internal thread of the sleeve,
   the pin being heated prior to being passed through the opening in the second component or after insertion into the opening in the second component or into the sleeve.

By heating the pin and subsequently pressing it, such that it is applied either against the wall of the second component, which wall takes the form of an internal thread, or against the internal thread of the sleeve, an external thread is created on the pin. This can be simply undone by unscrewing.

If the pin is joined to the first component, it is preferable to use a sleeve provided with an internal thread, so that the joint can be undone without damaging the first component and the pin. It is alternatively also possible to provide the pin with a predetermined breaking point and to remove it and, after undoing, to use a screw fastening for example to join the elements together again. In this case it is advantageous for a mark to be made in the first component at the position at which the pin is positioned and where a hole may be drilled into the first component in order to be able to insert the screw for refastening.

If the pin is joined to the first component and the opening in the second component is provided with an internal thread, such that the heated pin is applied against the wall of the second component, it is possible firstly to remove the first component for example by shearing off the pin or by drilling out and then to screw the pin out of the thread. This likewise allows separation of the first and second components and then opens up the possibility of refastening the first component to the second component for example with a screw.

The sleeve provided with an internal thread which is used may for example be a nut, a cap nut or similar component. It is preferable for the sleeve to take the form of a hexagon on the outside, like a nut for example, so as to be able to unscrew the sleeve to undo the components. Apart from being externally hexagonal, the sleeve may also exhibit any other external profile which allows undoing.

The method according to the invention is suitable in particular for joining components which are made of different materials to one another. In one embodiment, for example, the second component is made of a metallic material, glass or a ceramic and the first component of a plastics material. It is also possible for both components to be made of metallic materials, glass, a ceramic or a plastics material. It is in this case also possible for example to use different metallic materials, different ceramics or different plastics for the first and the second components. The method is used particularly preferably where at least the first component is made of a plastics material. The second component may in this case be made of a metallic material, for example.

If the first component is made of a plastics material, said material may be any desired plastics material, for example a thermoplastic plastics material or a thermosetting plastics material. Selecting a suitable plastics material depends for example on the intended use of the component and any media with which the component will come into contact.

The thermoplastic plastics material from which the pin is made is for example a polyamide, for example PA6, PA6.6, PA10.6, a polyester, for example polybutylene terephthalate (PBT) or polyethylene terephthalate (PET), acrylonitrile-butadiene-styrene copolymer (ABS), acrylonitrile-styrene-acrylic ester (ASA), polycarbonate (PC), polyethylene (PE), polypropylene (PP), polyetherether ketone (PEEK), polyether sulfone (PESU), polymethyl methacrylate (PMMA), polyoxymethylene (POM), polyphenylene sulfide (PPS), polystyrene (PS), polysulfone (PSU) or styrene-acrylonitrile copolymer (SAN).

If the pin of the thermoplastic plastics material is joined in one piece with the first component, it is preferable for the pin and the first component to be made of the same thermoplastic plastics material. If the first component is produced using an injection-molding process, the pin may then for example be molded directly onto said component during the injection-molding process. It is alternatively also possible, for example, to join the pin to the first component by a welding process. In this case it is also possible for the first component and the pin to be made from different polymers.

To achieve a media-tight joint between first component and second component, for example if the first component is an oil sump of a polymeric material and the second component is an engine block to which the first component is joined, it is preferable for the first component and the second component additionally to be adhesively bonded to one another. Any desired adhesive which is suitable for joining components may be used in this case. If the second component is made of a metallic material and the first component is made of a plastics material, then the use of silicone adhesives is particularly preferred.

Unlike a seal, which is inserted for example into a groove in a component and pressed against the second component, an adhesive bond has the advantage that no restoring forces which have an influence on media-tightness in the long run occur as a result of adhesive effects. In this way it is for example possible to prevent the plastics component from undergoing lasting deformation as a result of the pressure exerted. Using an adhesive bond has the additional advantage that a smaller number of fastening points is needed than is needed in the case for example of a screw fastening with inserted compression seal.

If the first component and the second component are additionally adhesively bonded to one another, the method of joining the two components is used in particular in order to achieve initial fastening, such that an adhesive may also be used which hardens over an extended period, for example several days. By joining the two components in accordance with the invention, the additionally adhesively bonded components are fixed to one another, such that the adhesive has sufficient time to achieve a minimum strength.

To allow automatic manufacture and joining of the components and furthermore to achieve precise positioning of the second component relative to the first component, it is preferable for a limit stop to be provided on the first component or on the second component, the limit stop abutting against the respective other component on joining. The limit stop ensures that the bond gap is precisely set when the components are pressed together.

If a limit stop is formed on the first component or on the second component, the limit stop may for example take the form of a peripheral shoulder or of pegs. If the limit stop takes the form of pegs, at least three pegs are preferably used, to achieve reliable positioning of the first component and second component.

A further advantage of a limit stop is that a uniform gap is obtained between the first component and the second component, which receives the adhesive used, for example. This results in a uniform, secure joint between the two components.

Where in particular the second component is made of a plastics material and the opening in the second component takes the form of an internal thread, it is preferable for a metallic insert to be accommodated in the second component, in which the internal thread is formed. The metallic insert prevents the softened pin from welding to the second component during pressing, so ensuring that the thread remains usable. Use of a metallic sleeve in which the internal thread has been cut is not necessary if the second component is made for example of a thermosetting plastics material, since thermoplastic plastics do not conventionally weld to thermosetting plastics.

If the second component is made of a ceramic material or of glass, it is also possible, but not necessary, to insert a metallic sleeve in which the internal thread has been formed.

Heating of the pin to make the latter deformable at least in part may proceed for example by contactless melting by radiant heating. Alternatively, it is also possible to heat the internal thread on the second component, for example, so as to heat the pin and make it deformable. The pin is in particular heated at that point on the pin at which the external thread is subsequently formed by pressing into the internal thread of the opening.

Besides heating of the pin or the internal thread on the second component by radiant heating it is also possible to heat the pin or the internal thread with a hot gas or by oscillations similar to an ultrasonic welding process.

Heating of the internal thread on the second component is possible in particular where the internal thread is made of a metallic material. This is the case for example where the second component is made of a metallic material or where the second component contains metallic sleeves in which the opening with the internal thread is formed.

It is additionally also possible, for example, to provide a heating plate, which is inserted at least partially into the opening formed with the internal thread from the opposite side from the pin. The pin is pressed against the heating plate and heated thereby until it deforms. If the opening provided with the internal thread is made of a metallic material, the internal thread of the opening is also heated by the heater, such that heat is also transferred to the pin from the side and the pin is also softened from the side.

The advantage of using radiant heating or a heating plate or of heating the opening provided with the internal thread is that the pin is heated and softened only at the point which is subsequently positioned in the opening provided with the internal thread, so forming the external thread. The remainder of the pin is not heated and softened, such that it remains stable during the joining process.

Exemplary embodiments of the invention are illustrated in the figures and explained in more detail in the following description.

In the figures:

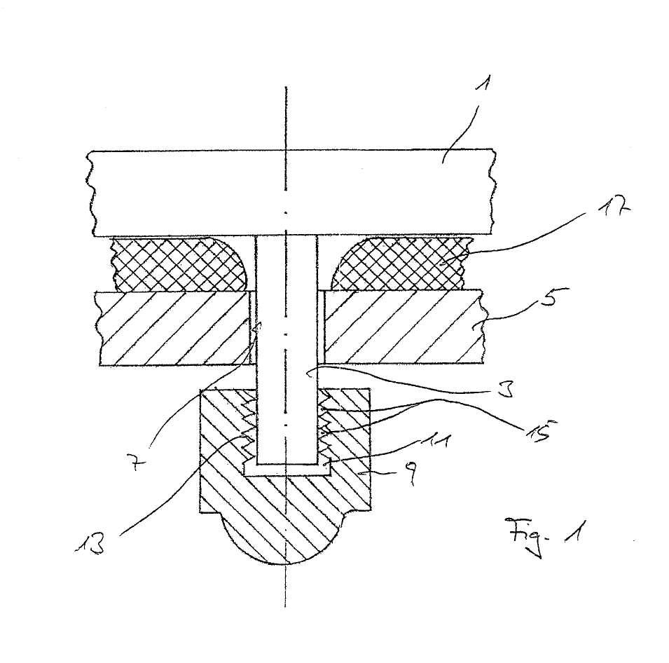

FIG. 1 shows a joint between two components, the pin being joined to the first component and a sleeve with internal thread formed therein being positioned on the pin,

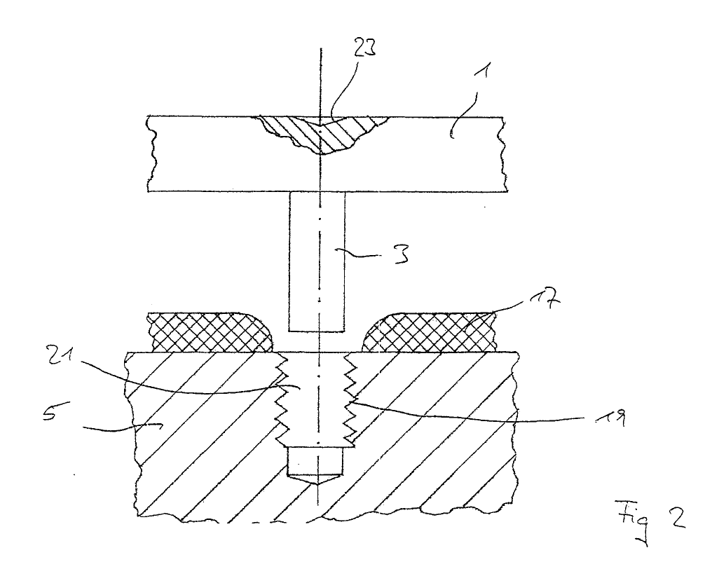

FIG. 2 shows a joint between two components, the pin being joined to the first component and the internal thread being formed in an opening in the second component,

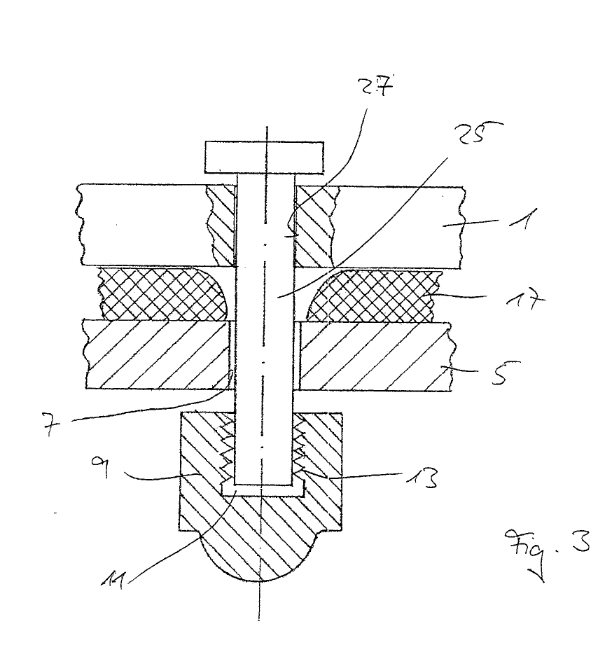

FIG. 3 shows a joint with a separate pin, in which a sleeve with internal thread formed therein is positioned on the pin,

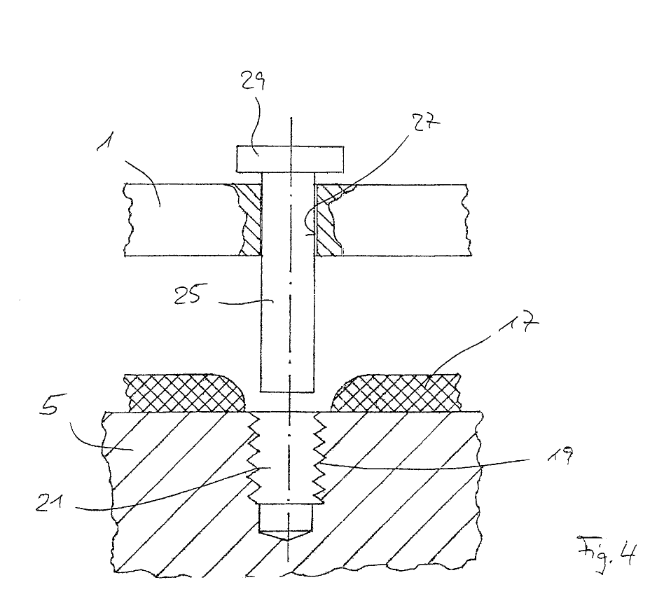

FIG. 4 shows a joint with a separate pin, the internal thread being formed in the second component,

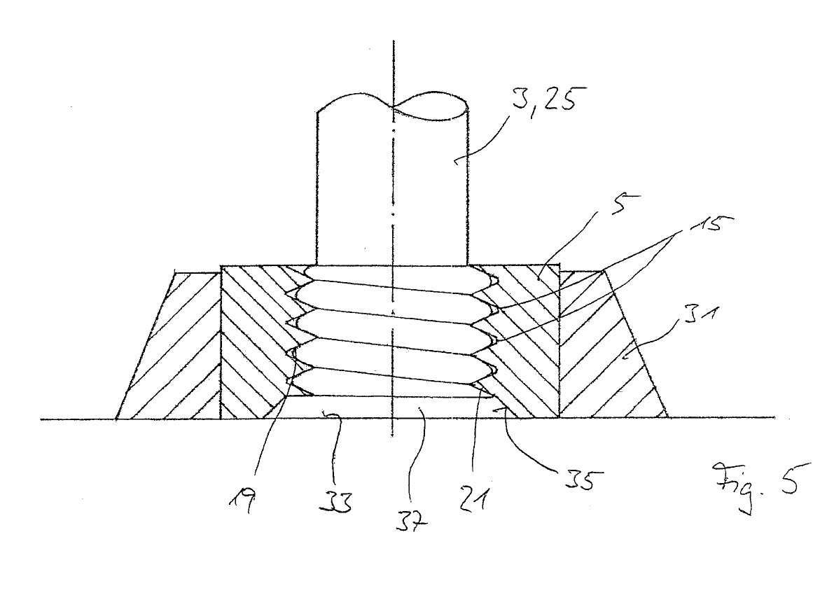

FIG. 5 shows a joint between two components, the second component being held by a clamping element and the thread in the second component being terminated by a widening bevel,

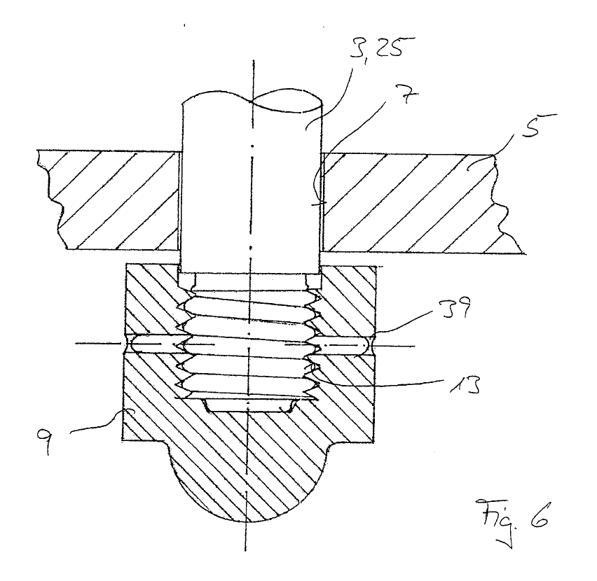

FIG. 6 shows a joint with antitwist protection.

FIG. 1 shows a joint between two components, the pin being joined to the first component and a sleeve with internal thread formed therein being positioned on the pin.

To join two components together, a first component 1 is joined to a pin 3. To this end, it is possible, for example, for the pin 3 to be made in one piece with the first component 1. In this case, the pin 3 may for example be molded directly on the first component 1 during production of the first component 1. If for instance the first component 1 is produced using an injection-molding process, the pin 3 may for example be molded directly onto the first component 1 during the injection-molding process. Alternatively, it is also possible for the pin 3 to be welded onto the first component, for example. However, it is preferable for the pin 3 to be molded onto the first component 1 during production of the first component 1. Where the pin 3, as shown in FIG. 1, is firmly joined to the first component 1, it is preferable for the first component 1 to be made of a thermoplastic plastics material. Any desired thermoplastic plastics material is suitable in this case. The preferred plastics material is a polyamide.

To join the first component 1 to a second component 5, the pin 3, which is joined to the first component 1, is passed through an opening 7 in the second component 5. The opening 7 is in this case preferably a bore with a circular cross section. The pin 3 is likewise preferably of circular cross section.

For fastening purposes, a sleeve 9 is positioned on the pin 3. The sleeve 9 comprises an opening 11, which is provided with an internal thread 13.

To join the first component 1 to the second component 5, the pin 3 is heated, at least in the zone which protrudes into the opening 11 in the sleeve 9, until said pin can be deformed. After heating, the sleeve 9 is pressed onto the pin 3, such that the latter deforms in such a way that the plastics material of the pin 3 is pressed into the turns 15 of the internal thread 13. In this way, an external thread is formed on the pin 3.

To obtain a media-tight joint between first component 1 and second component 5, it is advantageous to introduce an adhesive layer 17 between the first component 1 and the second component 5. By means of the adhesive layer 17, the first component 1 is additionally adhesively bonded to the second component 5. At the same time, the adhesive layer 17 acts as a sealing element. Where the first component 1 is additionally adhesively bonded to the second component 5 by the adhesive layer 17, the joint with the pin 3 is used in particular as an initial fastening, to ensure sufficient contact pressure during hardening of the adhesive of the adhesive layer 17.

An example of a suitable adhesive for the adhesive layer 17 is a silicone adhesive.

The joint as illustrated in FIG. 1 is suitable for example for joining a first component 1, made of a plastics material, to a second component 5 of a metallic material. However, it is also feasible for the second component 5 to be made of glass or a ceramic or of a plastics material.

The material of the sleeve 9 is preferably a metal. The sleeve 9 may for example be a nut or a cap nut, as are commercially available. Alternatively, the sleeve 9 may also take any other desired form. It is preferable for the sleeve 9 to have an external profile which allows unscrewing of the sleeve 9 from the pin 3 if the first component 1 needs to be separated from the second component 5. After unscrewing, the first component 1 can then be removed from the second component 5 and the pin 3, on which the external thread is provided, may then be used to join them back together, the sleeve 9 being screwed back onto the pin 3.

FIG. 2 shows a joint between two components, in which the pin is joined to the first component and the internal thread is formed in the second component.

Unlike in the embodiment shown in FIG. 1, in the case of the embodiment shown in FIG. 2 an internal thread 19 is provided in the second component 5. To join the first component 1 to the second component 5, the pin is inserted into the opening 21 in the second component 5 which is provided with the internal thread 19. By pressing the pin 3 in, the latter is again pressed against the wall of the internal thread 19, such that a thread is formed on the pin 3.

To be able to undo the first component 1 from the second component 5, it is possible, for example, to drill a hole in the first component 1 at the position at which the pin 3 is located. To this end, a mark 23 is applied on the outside of the first component at the position of the pin 3. The mark 23 may for example be a groove, an indentation or indeed a projection on the first component 1. Any other desired design and shape is also possible for the mark 23. What is essential is for the mark 23 to be such that it cannot be straightforwardly removed.

After drilling out at the location indicated by the mark 23, the first component 1 may be removed. The pin 3 remains in the opening 21 provided with the internal thread 19 in the second component 5. As a result of its threaded configuration, the pin 3 may then simply be screwed out of the second component 5.

In order subsequently to be able to join the first component 1 to the second component 5 again, a screw is inserted through the hole which was introduced into the first component 1 to allow it to be undone from the second component 5 and is screwed into the internal thread 19 in the second component 5.

Here too the joint produced with the pin 3 preferably serves as an initial fastening for the adhesive bonding of two components by means of an adhesive layer 17, the components being made of different materials.

An embodiment in which the joint is produced with a separate pin is shown in FIG. 3.

Unlike in the embodiment shown in FIG. 1, in the case of the embodiment shown in FIG. 3 a separate pin 25 is used.

To enable the joint to be produced using a separate pin 25, a first opening 27 is formed in the first component 1. To produce the joint, the separate pin 25 is passed through the first opening 27 in the first component 1, then through the opening 7 in the second component 5 and then into the sleeve 9 comprising the thread 13.

Using the separate pin 25 enables the pin 25 and the first component 1 to be made of different materials. In this case, the pin 25 is made of a thermoplastic plastics material, for example of polyamide. The first component may be made of any desired material, for example a plastics material, glass, a ceramic or a metal. Here too, the method is suitable in particular for joining two components of different materials.

FIG. 4 shows a joint between two components, in which a separate pin is used and the internal thread is formed in the second component, as in FIG. 2.

Unlike in the embodiment shown in FIG. 2, in the embodiment shown in FIG. 4 no pin is formed on the first component 1 but rather the first component 1 comprises an opening 27, through which a separate pin 25 may be passed. The joint is in this case produced by inserting the pin 25 through the opening 27 in the first component 1 into the opening 21 in the second component 5, which is provided with the internal thread. By heating the pin 25, the latter is pressed against the turns of the internal thread 19 of the opening 21 in the second component 5 and in this way a thread is formed.

To be able to undo the joint, it is advantageous for the separate pin 25 to comprise a head 29, which for example comprises an outer profile which allows the pin 25 to be screwed out of the internal thread 19. Alternatively, it is also possible to provide the head with a groove or a cross recess, to allow the pin 25 to be screwed out of the thread 19 using a screwdriver. Furthermore, a hexagon socket or any other desired design which enables the pin 25 to be screwed out of the internal thread 19 is also feasible.

If the first component 1 and the second component 5 need subsequently to be joined together again, the separate pin 25 may be used again, by screwing it into the internal thread 19 in the second component 5.

FIG. 5 shows a joint between two components, in which the second component is surrounded by a clamping element and the thread is terminated by a widening bevel.

If the opening in the second component 5 comprising the internal thread 19 is not closed at one end as shown in FIGS. 1 to 4 but rather is open at both ends, it is advantageous, for joining the first component 1 to the second component 5, to position the second component 5 in a clamping device 31. The clamping device 31 closes the opening 21 with the internal thread 19 in the second component 5.

When joining the first component 1 to the second component 5, the pin 3 or the separate pin 25 is then pressed against a base 33 of the clamping device 31. By pressing the pin 3 or the separate pin 25 against the base 33 of the clamping device 31, the deformable, heated pin is pressed into the turns 15 of the internal thread 19.

In the embodiment shown in FIG. 5, the internal thread 19 comprises an outwardly widening bevel 35. When pressure is exerted on the pin 3 or the expanding pin 25, the space formed by the bevel 35 is filled with the plastics material of the pin 3, 25. In this way, a widened portion 37 forms on the pin 3, 35. The widened portion 37 serves for example as antitwist protection and may also be used to check whether the first component 1 and the second component 5 have been separated from one another. When the joint is opened and the pin 3, 35 is screwed out of the internal thread 19, the widened portion 37 breaks off. If they are then joined back together, it is clearly visible that the widened portion is absent.

As well as the embodiment in which the thread 19 is formed in the second component 5, the embodiment shown in FIG. 5 may also be applied to a sleeve 9 with an internal thread 13 into which the pin 3, 25 is pressed. Here too, the opening 11 extends right through the sleeve 9 and is closed by the base 33 of the clamping device 31.

An alternative way of providing antitwist protection is shown in FIG. 6.

In the embodiment shown in FIG. 6, the pin 3, 25 is passed through the opening 7 in the second component 5 and pressed into the internal thread 13 in the sleeve 9, so forming an external thread on the pin 3, 25.

In the embodiment shown in FIG. 6, a cross hole 39 is additionally formed in the sleeve 9. When the heated and softened pin 3, 25 is pressed into the opening 11 with the internal thread 13 in the sleeve 9, first of all the opening 11 is completely filled, so forming an external thread on the pin 3, 25. Once the opening 11 is completely filled, plastics material from the pin 3, 25 continues to penetrate into the cross hole 39. Once the plastics material of the pin 3, 25 has hardened, the cross hole 39 contains pegs which are firmly joined in one piece with the pin 3, 25 and constitute antitwist protection. On opening, when the pin 3, 25 is screwed out of the internal thread 13, the pegs contained in the cross hole 29 are broken off. If the first component 1 and second component 5 are fastened together again with the pin 3, 25, antitwist protection is then no longer obtained.

In all of the embodiments shown in FIGS. 1 to 6 it is possible to heat the pin 3, 25 in the area in which the external thread is formed, for example by radiant heating. It is alternatively also possible, in particular if the second component, in which the internal thread 19 is provided, or the sleeve 9 is made of a metallic material, to heat the second component or the sleeve and in this way to heat the pin 3, 25, such that the latter becomes deformable and is applied against the internal thread 13, 19 when exposed to pressure.

Furthermore, it is also possible, in particular in the embodiment illustrated in FIG. 5, for the base 33 of the clamping device 31 to be heatable, for example, the pin being heated in this way until it becomes deformable.

The method of joining two components is suitable for example for fixing an oil sump of a polymeric material to an engine block. Further suitable applications are for example fixing a cylinder head cover, an intake manifold, a boost manifold, an oil separator or a windage tray to the engine block.

List of Reference Signs

1 First component

3 Pin

5 Second component

7 Opening

9 Sleeve

11 Opening in sleeve 9

13 Internal thread in sleeve 9

15 Turns

17 Adhesive layer

19 Internal thread in second component 5

21 Opening in second component 5

23 Mark

25 Pin

27 First opening

29 Head

31 Clamping device

33 Base

35 Bevel

37 Widened portion

39 Cross hole

1. A method of joining at least two components, comprising the following steps:
(a) heating a pin (3, 25) of a thermoplastic plastics material, such that it is at least partially deformable,
(b) guiding the pin (3, 25) of thermoplastic plastics material through an opening (21) in the second component (5), the pin (3, 25) being joined to the first component (1) or guided beforehand as a separate component through a first opening (27) in the first component (1),
(c) pressing the heated pin (3, 25) of thermoplastic plastics material, such that the pin (3, 25) is applied against the wall of the opening (21) in the second component (5), the wall taking the form of an internal thread (19), or inserting the pin (3, 25) into a sleeve (9) provided with an internal thread (13) and pressing the pin (3, 25), such that the latter is applied against the internal thread (13) of the sleeve (9),
the pin (3, 25) being heated prior to being passed through the opening (21) in the second component (5) or after insertion into the opening (21) in the second component (5) or into the sleeve (9).

2. The method as claimed in claim 1, wherein the components (1, 5) are made of different materials.

3. The method as claimed in claim 1, wherein the second component (5) is made of a metallic material, glass or a ceramic and the first component (1) of a plastics material.

4. The method as claimed in claim 3, wherein the pin (3) of thermoplastic plastics material is joined in one piece to the first component (1).

5. The method as claimed in claim 1, wherein the thermoplastic plastics material is a polyamide, a polyester, acrylonitrile-butadiene-styrene copolymer (ABS), acrylonitrile-styrene-acrylic ester (ASA), polycarbonate (PC), polyethylene (PE), polypropylene (PP), polyetherether ketone (PEEK), polyether sulfone (PESU), polymethyl methacrylate (PMMA), polyoxymethylene (POM), polyphenylene sulfide (PPS), polystyrene (PS), polysulfone (PSU) or styrene-acrylonitrile copolymer (SAN).

6. The method as claimed in claim 5, wherein the polyester is polybutylene terephthalate (PBT) or polyethylene terephthalate (PET).

7. The method as claimed in claim 1, wherein the first component (1) and the second component (5) are additionally adhesively bonded to one another.

8. The method as claimed in claim 1, wherein a limit stop is provided on the first component (1) or on the second component (5), the limit stop abutting against the respective other component on joining.

9. The method as claimed in claim 8, wherein the limit stop takes the form of a peripheral shoulder or of pegs.

10. The method as claimed in claim 1, wherein heating of the pin (3, 25) in step (a) proceeds in a contactless manner by radiant heating.

11. The method as claimed in claim 1, wherein, to heat the pin (3, 25) in step (a), the internal thread (19) in the second component (5) or the sleeve is heated.

12. The method as claimed in claim 1, wherein, after being passed through the opening (21) in the second component (5), the pin (3, 25) is pressed against a heating plate, so heating the pin.
